(19) United States
(12) Patent Application Publication
(10) Pub. No.: US 2026/0322952 A1
(43) Pub. Date: Oct. 15, 2026

(54) AUTONOMOUS MOBILE SECURITY AND JOB SITE MANAGEMENT SYSTEM WITH REAL-TIME SURVEILLANCE

(71) Applicant: Huxley Design, Inc., Kaysville, UT (US)

(72) Inventors: Jordan Thurber, South Ogden, UT (US); Daniel Wright, Farmington, UT (US)

(73) Assignee: Huxley Design, Inc., Kaysville, UT (US)

(21) Appl. No.: 19/643,516

(22) Filed: Apr. 9, 2026

Related U.S. Application Data
(60) Provisional application No. 63/787,405, filed on Apr. 11, 2025.

(51) Int. Cl. H04N 7/18; H02S 20/20; H04N 23/54; H04N 23/695; H02J 7/35

(52) U.S. Cl. CPC H04N 7/183; H02S 20/20; H04N 23/54; H04N 23/695; H02J 7/35

(57) ABSTRACT

A mobile security and job site management system is disclosed, comprising a mobile enclosure housing an electrical control system, an energy capturing device mounted to the mobile enclosure to power the system, a mast pivotally attached to the mobile enclosure, a mast deployment mechanism connected to the mast and the electrical control system, and a camera mounted on the mast for real-time surveillance and motion detection. The mast is deployable from a position adjacent the mobile enclosure to an elevated position above the mobile enclosure to elevate the camera to an observatory position. A method for securing a location involves providing the mobile enclosure with the electrical control system, mast deployment system, mast, and camera, charging an electrochemical storage system, raising the mast to elevate the camera, and activating the camera for real-time surveillance and motion detection of the location and surroundings.

### PRIORITY STATEMENT

This application claims priority to U.S. Provisional Patent Application No. 63/787,405, filed Apr. 11, 2025, and entitled, “AUTONOMOUS MOBILE SECURITY AND JOB SITE MANAGEMENT SYSTEM WITH REAL-TIME SURVEILLANCE”, hereby incorporated by reference in its entirety.

### FIELD OF THE INVENTION

The present disclosure relates generally to remote, autonomous security and surveillance. More particularly, but not exclusively, the present disclosure relates to a mobile security and job site management system.

### BACKGROUND

Construction, industrial, and remote job sites often require robust security solutions to protect valuable equipment, materials, and personnel. However, many existing security systems are either too bulky, requiring significant space, or rely on external power sources, such as AC power, which may not be available in remote locations. Additionally, traditional systems may lack the durability to withstand harsh environmental conditions or the advanced technology needed for intelligent monitoring, such as real-time video surveillance and motion detection.

Therefore, what is needed is a compact, self-sustaining, and durable security system that can be easily deployed in space-constrained and remote locations while providing advanced surveillance capabilities without the need for AC power. The present disclosure addresses these needs by offering an autonomous, sustainable, mobile security solution with a small footprint, a deployable mast, and AI-integrated cameras, with flexibility for alternative aspects to suit diverse applications.

### SUMMARY

Therefore, it is a primary object, feature, or advantage of the present invention to improve over the state of the art.

It is a further object, feature, or advantage of the present invention to provide a compact, solar-powered security system that operates autonomously without the need for AC power in remote locations.

It is a still further object, feature, or advantage of the present invention to enable real-time video surveillance and motion detection with AI-powered cameras for enhanced security monitoring.

Another object, feature, or advantage is to facilitate easy deployment and transport with a mobile enclosure featuring a deployable mast, tine guides for porting, and removable stabilizing components.

Yet another object, feature, or advantage is to ensure durability and reliability in harsh environmental conditions through robust construction and weatherproof components.

In at least one aspect, an autonomous mobile security and job site management system with real-time surveillance is disclosed. The mobile security and job site management system includes a mobile enclosure housing an electrical control system. An energy capturing device is mounted to the mobile enclosure and is configured to power the electrical control system. A mast is attached to the mobile enclosure and a mast deployment system is connected to the mast and the electrical control system. A camera is mounted on the mast and connected to the electrical control system and the camera is configured for real-time surveillance and motion detection. The mast is deployable from a position adjacent the mobile enclosure to an elevated position above the mobile enclosure by the mast deployment system for elevating the camera to an observatory position.

In at least one other aspect, an apparatus for mobile security and job site management is disclosed. The apparatus includes, for example, a mobile enclosure housing an electrical controller and an energy capturing device hingedly mounted to the mobile enclosure. The energy capturing device is configured to power the electrical controller. A mast is pivotally attached to the mobile enclosure and a mast deployment mechanism is connected to the mast and the electrical controller. A camera is mounted on the mast and connected to the electrical controller, and the camera is configured for real-time surveillance and motion detection. The mast is deployable from the position adjacent the mobile enclosure to the elevated position above the mobile enclosure by the mast deployment system for elevating the camera to an observatory position.

In still another aspect, a method for securing a location with real-time video surveillance and motion detection is disclosed. The method involves setting up a portable box with a control unit, a mechanism to raise a pole, a pole, and a camera on the pole, charging a battery to power the control unit, lifting the pole from a position next to the box to a higher position to raise the camera for a better view, and turning on the camera to watch the area and detect movement in real time.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIG. 1 is a pictorial rendering of a mobile enclosure showing an energy capturing device and a mast in a raised position according to at least one exemplary aspect of a mobile security and job site management system.

FIG. 2 is a pictorial rendering of the mobile enclosure with the mast lowered.

FIG. 3 is a pictorial rendering of the mobile enclosure with the mast fully raised and nested, showing the camera at the top in an observation position.

FIG. 4 is a pictorial rendering of the mobile enclosure illustrating its cabinets and internal structure with open doors.

FIG. 5 is a pictorial rendering of a camera and communications array of the mobile enclosure in accordance with an exemplary aspect of the mobile security and job site management system.

FIG. 6 is a flow diagram illustrating a method for securing a location with real-time video surveillance and motion detection.

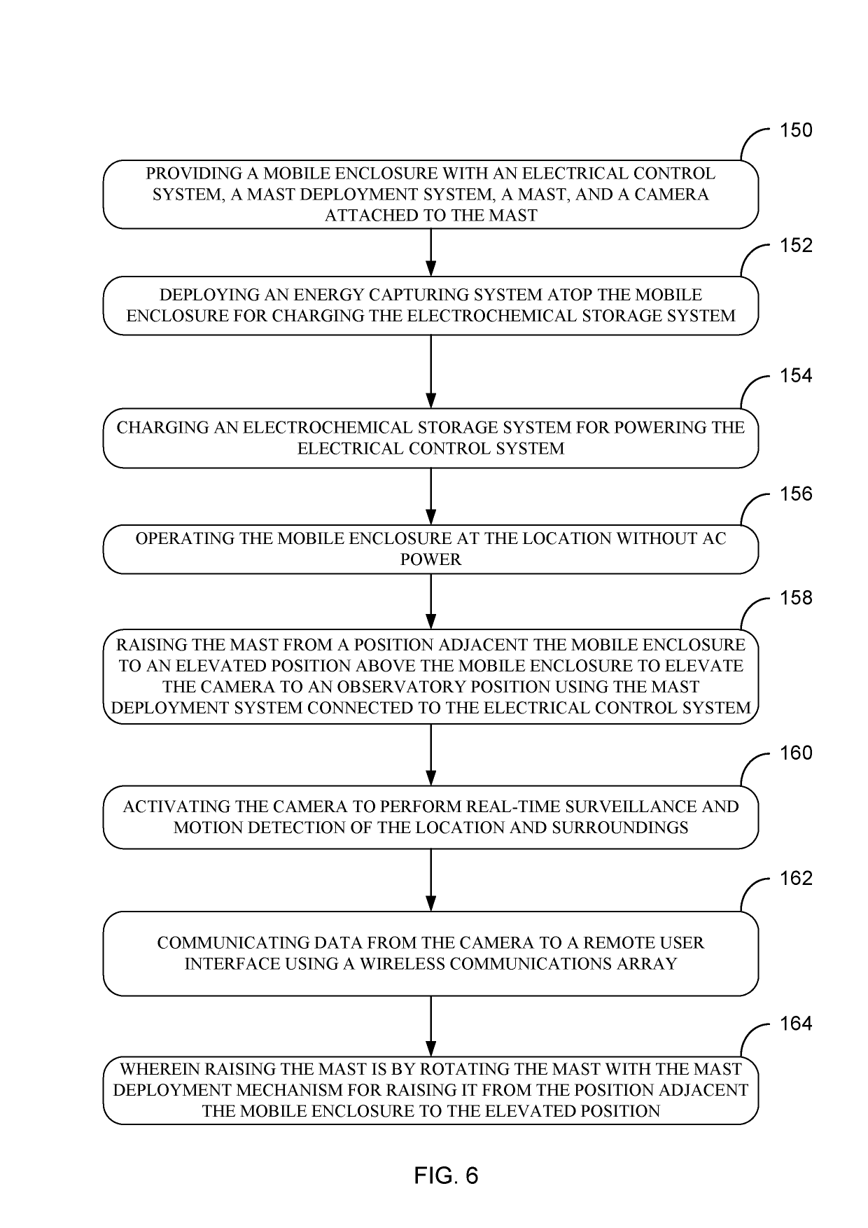

### DETAILED DESCRIPTION

A mobile security and job site management system 100 is a compact, solar-powered security system designed to secure a location with real-time video surveillance and motion detection in construction, industrial, and remote environments. System 100 is engineered to provide advanced surveillance and site management capabilities while maintaining a small footprint and durable construction, with alternative aspects, materials, and processes to broaden its applicability across various environments and use cases.

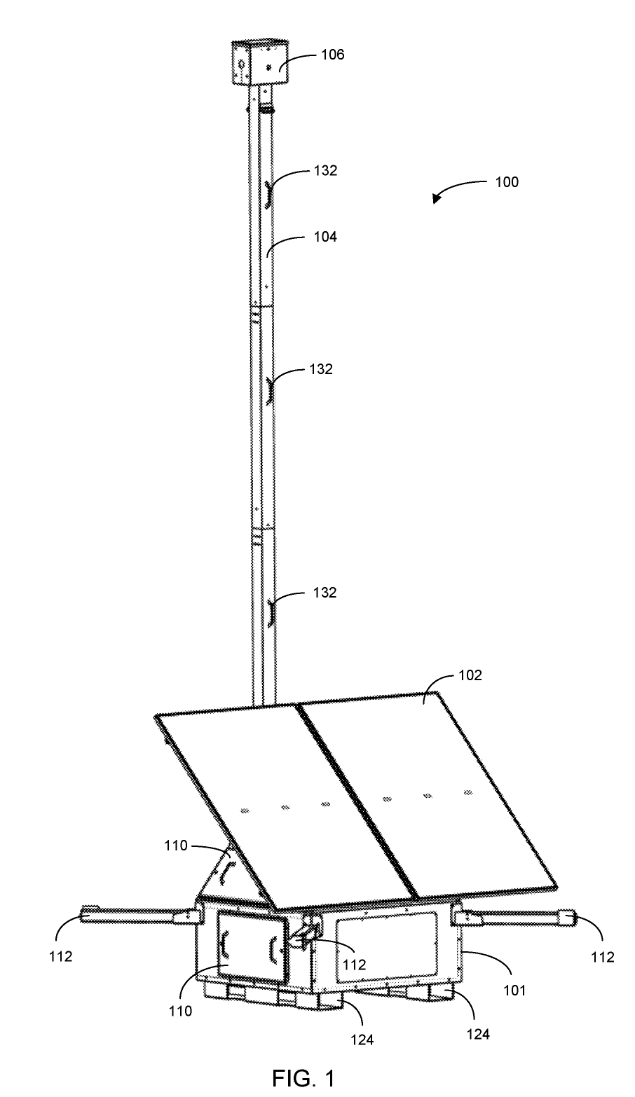

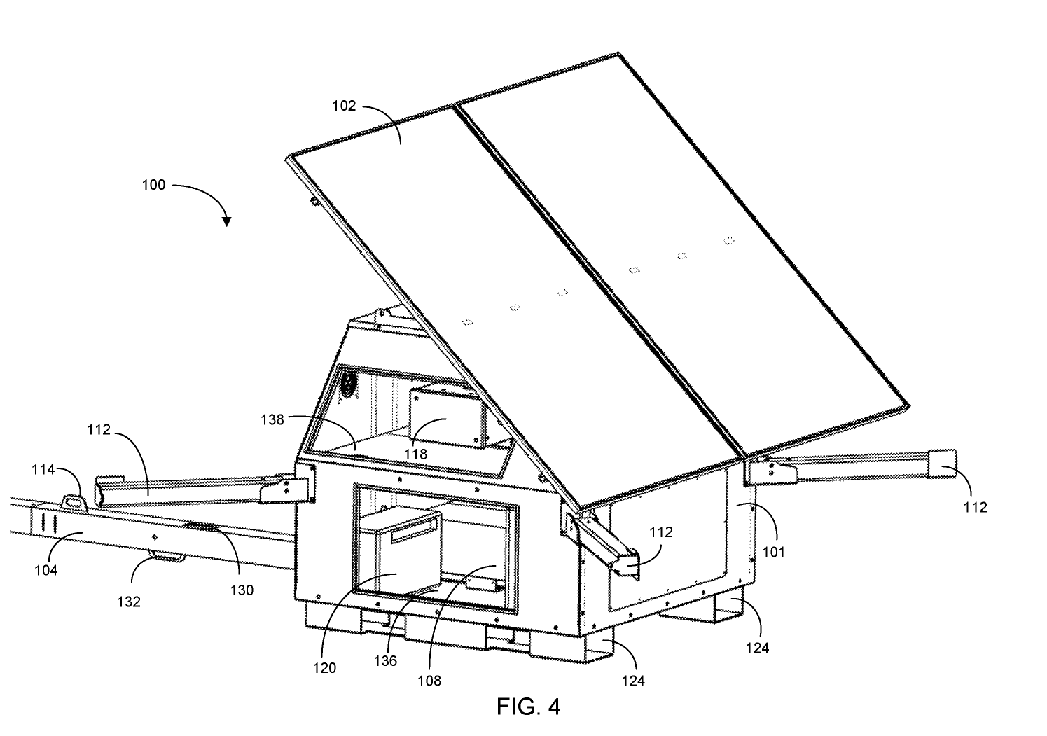

A mobile enclosure 101 is compact, as shown in FIGS. 1-5, and forms the core structural component of mobile security and job site management system 100. In the primary aspect, mobile enclosure 101 is constructed from aluminum, which provides a lightweight yet strong framework, and the exterior is coated with a durable powder coat finish to prevent rust and enhance longevity, making it suitable for harsh environmental conditions. Mobile enclosure 101 includes a main cabinet 136 and a side cabinet 138, which house an electrical controller 118, electrochemical storage device 120, and mast deployment mechanism 108, and feature multiple access doors 110, as seen in FIGS. 1 and 4, for easy maintenance and equipment access, with hinged doors 110 that can be secured with locks for added security. Main cabinet 136 serves as the primary compartment for housing critical components such as mast deployment mechanism 108 and an electrochemical storage device 120, providing a secure and weatherproof environment for these sensitive electronics, such as electrical controller 118. Side cabinet 138, typically smaller, provides storage for electrical controller 118 and space for auxiliary components, tools, or wiring, and can be used to house camera 106 and communications array 128 when not mounted on the mast 104, ensuring easy access for maintenance or reconfiguration.

The base of mobile enclosure 101 includes a pair of tine guides 124 for transporting the apparatus, such as with a forklift, and stabilizing arms 112, visible in FIGS. 1 through 4, to ensure stability during deployment. Tine guides 124 are integrated into the base of mobile enclosure 101 as reinforced slots, designed to align with standard forklift tines, allowing the entire system to be lifted and moved securely without requiring additional equipment or disassembly. In alternative aspects, mobile enclosure 101 may be constructed from other materials such as stainless steel, galvanized steel, or high-strength polymers to suit specific environmental conditions or weight requirements, with stainless steel being suitable for highly corrosive environments like coastal areas, and high-strength polymers reducing weight for frequent transport.

The mobile enclosure 101 has approximate dimensions of 56 inches in length, 40 inches in width, and 52 inches in height, with a weight of approximately 150 pounds when fully assembled, ensuring portability while maintaining structural integrity. Variations in size are contemplated in order to house the requisite components of system 100. The protective coating may also vary, including options such as galvanization, anodization, or weather-resistant paint, depending on the material and environmental demands. The stabilizing mechanism can also vary, using weighted base plates or ground-anchoring systems like stakes or bolts, and stabilizing arms 112 may be adjustable in length or angle, or replaced with foldable outriggers to accommodate uneven terrain. Additionally, mobile enclosure 101 may include wheels or casters in some aspects to enhance mobility, with locking mechanisms to secure the unit in place during deployment, and access doors 110 may vary in design, including sliding doors, roll-up panels, or removable panels, with locking mechanisms such as electronic locks, biometric locks, or combination locks providing enhanced security options.

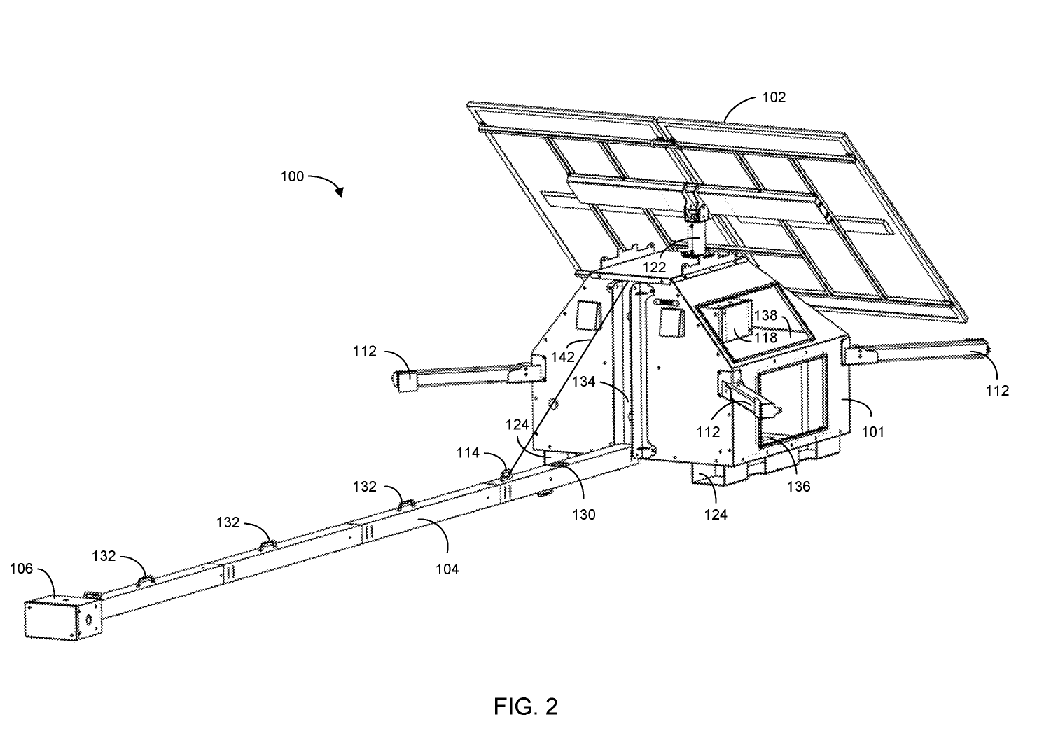

In the primary aspect, the system is autonomously powered entirely by utilizing a large energy capturing device 102, such as a solar panel, mounted on the top of mobile enclosure 101, as shown in FIGS. 1-4, which is angled to maximize sunlight exposure and supported by a sturdy mounting assembly 122, allowing it to be adjusted between a deployed position as seen in FIG. 2 for capturing energy and an undeployed position for transport. Mounting assembly 122 can be adjusted to place the energy capturing device 102 in the optimal position and/or angle for collecting solar radiation. Energy capturing device 102 charges an electrochemical storage device 120, housed within main cabinet 136 of mobile enclosure 101, which provides continuous power to the system’s components, including the camera 106, mast deployment mechanism 108, electrical controller 118, speaker 116, and communications array 128 eliminating the need for AC power and making system 100 ideal for autonomous use and remote locations.

In alternative aspects, the power system may include hybrid configurations that combine solar energy with other power sources, such as wind turbines, fuel cells, or a backup generator, to ensure continuous operation in low-energy capture conditions, with a small wind turbine potentially mounted on the mast 104 to supplement solar power in windy environments, or a port for connecting to an external power grid or portable generator as a backup option. Energy capturing device 102 itself may vary in design, including flexible solar panels, bifacial panels capturing sunlight from both sides, or modular panels that can be added or removed based on power needs, and mounting assembly 122 may include motorized tracking systems to automatically adjust device’s 102 angle throughout the day, or device 102 may be detachable and mounted separately from mobile enclosure 101, connected via a cable 142, to allow for placement in a more energy-rich location.

Electrochemical storage device 120 may also vary, using different battery chemistries such as lithium-ion, lead-acid, or solid-state batteries, depending on cost, weight, and performance requirements, and may include modular battery packs that can be swapped out or expanded to increase power capacity. A key feature of the disclosure is its mast 104, which is used to elevate surveillance camera 106 to an observatory position for a wider field of view, and in the primary aspect, mast 104 is a modulated or segmented pole design that is pivotally attached to mobile enclosure 101, as visible in FIGS. 1 through 3, raised and lowered using a mast deployment mechanism 108, such as a motor-driven winch, connected to electrical controller 118 housed within main cabinet 136 of mobile enclosure 101. Mast 104 is supported by a seat 134 in a sidewall of mobile enclosure 101, which provides a stable base for pivoting, and includes a lifting bracket 114 to assist in raising mast 104, a locking bracket 130 to secure the mast 104 in its raised position, and carry handles 132 on each section for easy handling during assembly and disassembly. Seat 134 is a reinforced platform or socket integrated into the sidewall surface of the mobile enclosure 101, designed to securely hold the base and lower portion of mast 104 while allowing it to pivot smoothly during deployment, and is typically constructed from the same durable material as mobile enclosure 101 to withstand the mechanical stresses of raising and lowering the mast 104. Lifting bracket 114 is a metal loop or hook attached near the midpoint of mast 104, providing a connection point for the cable of mast deployment mechanism 108 to apply the necessary force to raise mast 104 from its lowered position to its elevated position. Locking bracket 130, shown in FIG. 2, is a clamp or latch mechanism, typically located near the base of the mast 104, that engages with a corresponding slot or pin on mobile enclosure 101 to lock mast 104 in its raised position, preventing unintended movement during operation or transport. Carry handles 132 are ergonomically shaped grips, often made of metal or reinforced plastic, attached to each section of mast 104, typically near the middle of each section, to facilitate manual handling during assembly, disassembly, and transport, ensuring that users can safely and comfortably maneuver mast 104 without risk of injury. In alternative aspects, the mast 104 may be telescoping, allowing it to collapse into a smaller form factor for transport and extend during deployment, and the mast 104 material may vary, including options such as carbon fiber for reduced weight, steel for added strength, or composite materials for a balance of weight and durability, with adjustable height to suit different applications. Mast deployment mechanism 108 may also vary, using a manual crank, hydraulic system, or pneumatic system instead of an electric motor-driven motor, with a hydraulic system providing smoother operation in heavy-duty applications, or a manual crank for cost-sensitive implementations, and electrical controller 118 may include remote operation via a mobile app or wireless remote to enhance user convenience. Mast 104 may also include additional features, such as integrated LED floodlights for nighttime surveillance, weather sensors like anemometers or rain gauges for environmental monitoring, or communication antennas for Wi-Fi or cellular connectivity for communications array 128, and may be modular to allow for the attachment of different payloads atop mast 104.

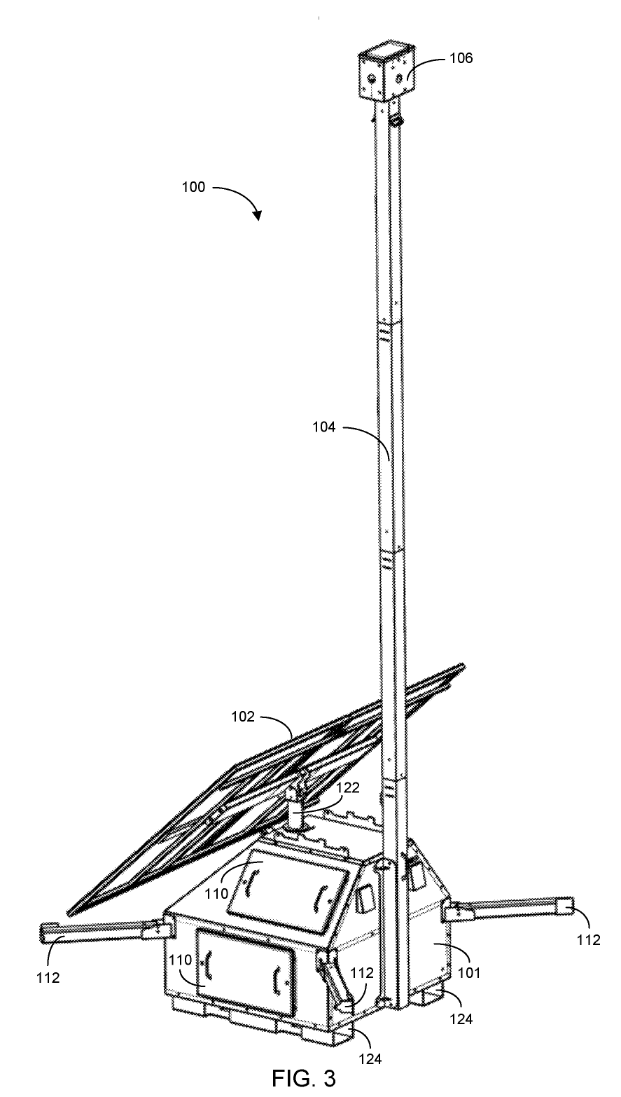

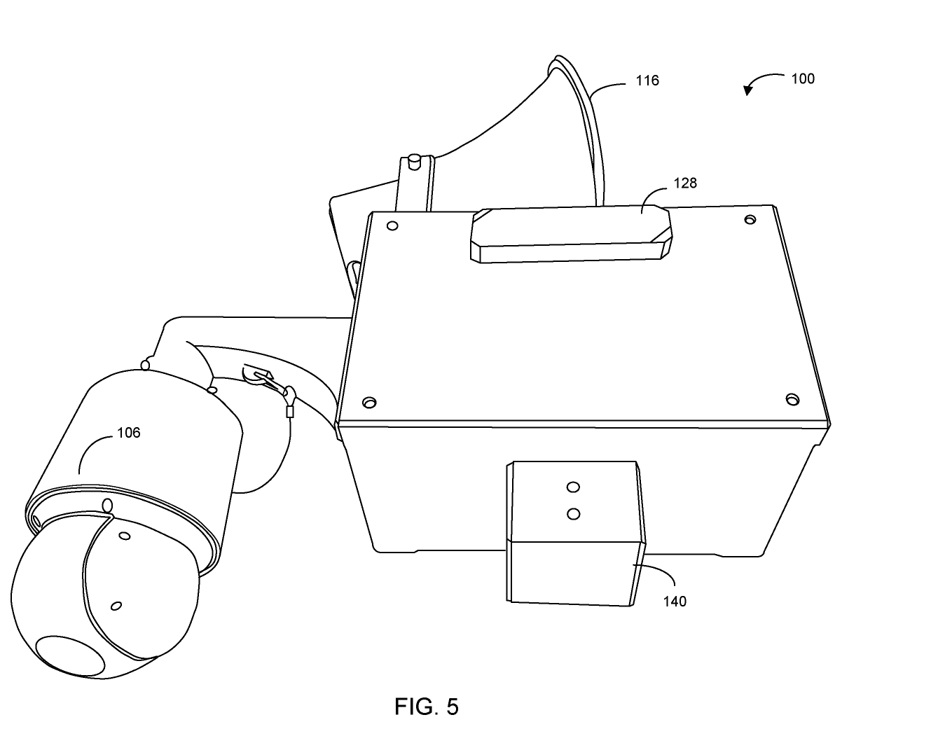

FIG. 2 shows mast 104 in a lowered position adjacent the ground or supporting surface of mobile enclosure 101, and FIG. 3 shows the mast 104 fully raised to an elevated position above mobile enclosure 101, with camera 106 positioned at the top, allowing for quick and secure deployment to an observatory position.FIG. 5 illustrates an exemplary configuration of camera 106, which includes a communications array 128, a speaker 116, and camera 106. Speaker 116 is connected to electrical controller 118 and communications array 128 to provide audible alerts, sirens, and voice warnings, with a volume range of 80 to 120 decibels and a broadcast range of up to 50 meters, and is constructed from durable materials like aluminum or reinforced plastic to withstand environmental conditions. In one aspect, a microphone (not shown) may be configured to surveille for sound. Camera 106 and/or mobile enclosure 101 may be configured with the microphone for surveilling for sound. Data in the form of video collected from camera 106 and audio collected from the microphone is wirelessly communicated to a remote operator or user system using communications array 128 operated by electrical controller 118. Similarly, audible commands, instructions, and warnings are communicated from the remote operator or user system via the communications array 128 operated by electrical controller 118 and announced using speaker 116. The AI-powered camera 106 includes advanced algorithms for facial recognition, license plate recognition, and object classification, enabling it to identify authorized personnel, detect intruders, and track vehicles, with motion detection sensitivity adjustable to filter out false positives (e.g., small animals, wind-blown debris).

The design of the mobile security and job site management system 100 emphasizes modularity to enhance its portability, ease of assembly, and adaptability to various environments. Mast 104 is constructed with sections that can be easily assembled, transported, and disassembled, each section equipped with carry handles 132 for convenient handling during setup and breakdown. This modular construction allows the mast 104 to be broken down into manageable parts for transport and quickly reassembled at the job site, ensuring efficient deployment. Camera 106, speaker 116, and communications array 128 are also modular, designed to be assembled, transported, and reassembled to the mast 104 with minimal effort, and are mounted to mast 104 using a mounting bracket 140. In some aspects, camera system 106 and communications array 128 can integrate electrical controller 118, elevating it above ground level and out of reach to protect it from tampering or environmental hazards, such as flooding or debris, while maintaining its functionality for real-time surveillance and motion detection. The stabilizing components, including stabilizing arms 112, are similarly modular, allowing them to be removed, transported, and reassembled to the mobile enclosure 101 at the site. These stabilizing components are critical for preventing the mobile enclosure 101, mast 104, and camera 106 from tipping or being tipped over, whether by environmental factors like strong winds or unwanted human interaction, ensuring the system's stability and security in diverse conditions.

In the primary aspect, the system includes an AI-powered camera 106 for advanced surveillance, as shown in FIG. 5, mounted at the top of mast 104 using mounting bracket 140 to provide a high vantage point for monitoring the location and surroundings, with AI integration enabling real-time surveillance, motion detection, and intelligent alerting, reducing the need for constant human monitoring. Camera 106 is connected to the electrical controller 118, visible in FIG. 5, which processes data and sends alerts to a remote user interface via a communications array 128, also mounted on the mounting bracket 140, such as by using a mobile app or computer system, and camera 106 is weatherproof to ensure reliable performance in harsh conditions.

In alternative aspects, surveillance system 100 may include different types of cameras 106, such as thermal imaging cameras for nighttime or low-visibility conditions, 360-degree panoramic cameras for broader coverage, or high-resolution cameras for detailed imaging, with AI algorithms incorporating features like facial recognition, license plate recognition, or object classification to enhance security capabilities, such as identifying authorized personnel or tracking vehicles. Camera 106 may also include additional sensors, such as infrared sensors, radar, or LIDAR, to complement AI-powered camera 106, with radar detecting motion in foggy conditions, and electrical controller 118 may support edge computing for local data processing or cloud-based processing for complex AI models.

The alerting system may include audible alarms, flashing lights, or automated voice messages to deter intruders, utilizing the speaker 116 for audio alerts, and the remote interface may include a web-based dashboard, dedicated hardware controller, or integration with third-party security systems. In the primary aspect, the mobile enclosure 101 is designed for durability and ease of use, with the aluminum construction and powder coat finish ensuring it can withstand harsh weather, physical impacts, and prolonged exposure to the elements, and the compact design allows deployment in space-constrained environments without obstructing operations, with stabilizing arms 112 providing flexibility for securing or moving the unit, and lightweight materials and modular design enhancing mobility between locations.

The manufacturing process for mobile enclosure 101 may vary depending on the materials and design, with the primary aspect involving fabrication from aluminum sheets that are cut, bent, and welded, followed by a powder coat finish, while alternative aspects may use injection molding for polymer-based designs, casting for steel components, or 3D printing for rapid prototyping or custom parts, with assembly processes including modular assembly or fully integrated assembly. The coating process may include electroplating, chemical vapor deposition, or spray painting, and manufacturing may incorporate automation like robotic welding or CNC machining to improve precision and reduce production time.

In at least one of its uses, to secure a location with real-time video surveillance and motion detection system 100, the user provides mobile enclosure 101 with the electrical controller 118, mast deployment mechanism 108, mast 104, and camera 106, communications array 128, and speaker 116 attached to the mast 104 (Step 150), deploys the energy capturing device 102 atop the mobile enclosure 101 (Step 152) for charging the electrochemical storage device 120, charges the electrochemical storage device 120 for powering the electrical controller 118 (Step 154), operates system 100 at the location without AC power (Step 156), raises the mast 104 by rotating it using the mast deployment mechanism 108 from a position adjacent mobile enclosure 101 to an elevated position above mobile enclosure 101 to elevate the camera 106 to an observatory position (Step 158), automatically adjusts surveillance parameters using AI algorithms (e.g., sensitivity, focus areas) (Step 159), activates camera 106 to perform real-time surveillance and motion detection of the location and surroundings (Step 160), communicates data from the camera 106 to a remote user interface using wireless communications array 128 (Step 162), and optionally rotates the mast 104 with the mast deployment mechanism 108 for raising it from the position adjacent mobile enclosure 101 to the elevated position (Step 164), with the system operating autonomously and requiring minimal maintenance, and when the job is complete, mast 104 is lowered, and the unit is transported to a new location using, in at least one example, tine guides 124 on the base of mobile enclosure 101.

In alternative aspects, the deployment process may vary, with a motorized tracking system automatically adjusting the energy capturing device’s 102 angle, a hydraulic deployment mechanism controlled via a pump, or automated setup routines like self-calibration of camera 106, and system 100 may support different operational modes, such as low-power mode, high-security mode, or standby mode, with additional features like lighting or weather sensors activated based on conditions, and transport options including towing, mounting on a trailer, or disassembling for air transport.

Mobile security and job site management system 100 provides numerous benefits that distinguish it from existing systems. Its compact design ensures it can be deployed in space-constrained locations without obstructing operations, while its flexible power options, primarily solar with alternatives like hybrid systems, eliminate the need for AC power in many scenarios, reducing operational costs and enabling use in remote locations. The advanced surveillance capabilities, driven by AI-powered cameras with alternatives such as thermal imaging or radar, deliver intelligent monitoring that minimizes the need for human oversight, enhancing efficiency and security.

The system’s durability, achieved through aluminum construction with a powder coat finish or alternative materials like stainless steel, ensures long-term reliability in harsh conditions, making it suitable for diverse environments. Additionally, the ease of deployment, facilitated by a mast deployment mechanism with alternatives like hydraulic systems, allows for quick and secure setup, saving time at busy locations. Finally, the system’s portability, supported by lightweight materials, a modular design, tine guides for transport, and options for wheels or towing, makes it easy to transport between locations, providing flexibility for dynamic project needs.

Mobile security and job site management system 100 is a novel and innovative system that addresses the challenges of securing and managing locations in construction, industrial, and remote environments. By combining a compact design, flexible power options, a deployable mast, and advanced surveillance technologies, the disclosure provides a sustainable, efficient, and technologically advanced solution for location security. The inclusion of alternative aspects, materials, and processes ensures the disclosure can be adapted to a wide range of applications and environments.

The invention is not to be limited to the particular embodiments described herein. In particular, the invention contemplates numerous variations in Mobile Security and Job Site Management System. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes, or methods of the invention. It is understood that any other modifications, substitutions, and/or additions can be made, which are within the intended spirit and scope of the invention.

What is claimed is:

1. An autonomous mobile security and job site management system with real-time surveillance comprising:
a mobile enclosure housing an electrical control system;
an energy capturing device mounted to the mobile enclosure, the energy capturing device configured to power the electrical control system;
a mast attached to the mobile enclosure;
a mast deployment system connected to the mast and the electrical control system;
a camera mounted on the mast and connected to the electrical control system, the camera configured for real-time surveillance and motion detection;
wherein the mast is deployable from a position adjacent the mobile enclosure to an elevated position above the mobile enclosure by the mast deployment system for elevating the camera to an observatory position.

2. The system of claim 1, further comprising:
a motor connected to the electrical control system and configured to move the mast from the position adjacent the mobile enclosure to the elevated position.

3. The system of claim 1, wherein the mast remains a fixed length during movement from the position adjacent the mobile enclosure to the elevated position.

4. The system of claim 1, further comprising:
a communications array connected to the electrical control system, the communications array configured to send real-time surveillance and motion detection to a remote user and/or user interface.

5. The system of claim 1, wherein the camera comprises an AI-powered camera configured for real-time surveillance and motion detection.

6. The system of claim 1, further comprising:
one or more stabilizing arms extending from the mobile enclosure to enhance stability of the mobile enclosure and the mast in both the position adjacent the mobile enclosure and the elevated position.

7. The system of claim 1, further comprising:
an electrochemical storage system connected to the energy capturing device and the electrical control system, the electrochemical storage system charged by the energy capturing device, the electrochemical storage system configured to provide continuous power to the camera, electrical control system, and mast deployment system.

8. An apparatus for mobile security and job site management, the apparatus comprising:
a mobile enclosure housing an electrical controller;
an energy capturing device hingedly mounted to the mobile enclosure, the energy capturing device configured to power the electrical controller;
a mast pivotally attached to the mobile enclosure;
a mast deployment mechanism connected to the mast and the electrical controller;
a camera mounted on the mast and connected to the electrical controller, the camera configured for real-time surveillance and motion detection;
wherein the mast is deployable from the position adjacent the mobile enclosure to the elevated position above the mobile enclosure by the mast deployment system for elevating the camera to an observatory position.

9. The apparatus of claim 8, further comprising:
one or more stabilizing arms extending from the mobile enclosure to enhance stability of the mobile enclosure and the mast in both a position adjacent the mobile enclosure and an elevated position.

10. The apparatus of claim 8, wherein the mast remains a fixed length during movement from the position adjacent the mobile enclosure to the elevated position.

11. The apparatus of claim 9, wherein the stabilizing arms are detachable to facilitate transport of the apparatus.

12. The apparatus of claim 8, further comprising:
a communications array connected to the electrical controller, the communications array configured to send real-time surveillance and motion detection to a remote user and/or user interface.

13. The apparatus of claim 8, wherein the energy capturing device have a deployed and undeployed position for transport.

14. The apparatus of claim 8, wherein the mobile enclosure includes a base having a pair of tine guides for transporting the apparatus.

15. The apparatus of claim 8, further comprising:
an electrochemical storage device connected to the energy capturing device, the electrical controller, the camera, and the mast deployment mechanism, wherein the electrochemical storage device is charged by the energy capturing device.

16. A method for securing a location with real-time video surveillance and motion detection, the method comprising:
providing a mobile enclosure with an electrical control system, mast deployment system, a mast, and a camera attached to the mast;
charging an electrochemical storage system for powering the electrical control system;
raising the mast from a position adjacent the mobile enclosure to an elevated position above the mobile enclosure to elevate the camera to an observatory position using the mast deployment system connected to the electrical control system; and
activating the camera to perform real-time surveillance and motion detection of the location and surroundings.

17. The method of claim 16, further comprising:
rotating the mast with the mast deployment system for raising it from the position adjacent the mobile enclosure to the elevated position.

18. The method of claim 16, further comprising:
deploying an energy capturing system atop the mobile enclosure for charging the electrochemical storage system.

19. The method of claim 16, further comprising:
operating the mobile enclosure at the location without AC power.

20. The method of claim 16, further comprising:
communicating data from the camera to a remote user interface using a wireless communications array.
